(19) United States
(12) Patent Application Publication
(10) Pub. No.: US 2009/0072891 A1
(43) Pub. Date: Mar. 19, 2009

(54) Varactor-based charge pump

(76) Inventor: Srinivas Perisetty, Santa Clara, CA (US)

Correspondence Address: G. VICTOR TREYZ, FLOOD BUILDING, 870 MARKET STREET, SUITE 984, SAN FRANCISCO, CA, 94102, US

(21) Appl. No.: 11/901,019

(22) Filed: Sep. 14, 2007

(51) Int. Cl. G05F 1/10

(52) U.S. Cl. 327/536

(57) ABSTRACT

Charge pump circuitry for an integrated circuit is provided. The integrated circuit may be a programmable integrated circuit that has programmable elements that provide static control signals. The charge pump circuitry may contain a number of stages. Each stage may include a diode and a capacitor. Oscillator and control circuitry may generate clock signals. The clock signals may be applied to the capacitors in the charge pump stages. The charge pump circuitry may provide an output voltage. A programmable voltage regulator may be used to regulate the output voltage. The static control signals may be used to adjust the oscillator and control circuitry. The static control signals may also be used to adjust the programmable voltage regulator. The capacitors in the charge pump may be based on varactors.

### BACKGROUND

This invention relates to charge pumps, and more particularly, to varactor-based charge pump circuitry for integrated circuits such as programmable integrated circuits.

Integrated circuits generally have a number of power pins and data pins. An integrated circuit's data pins are used to receive input signals from other integrated circuits and other signal sources. An integrated circuit's data pins are also used to provide output signals to components that are connected to the integrated circuit. Power pins are used to provide power supply voltages to an integrated circuit. In a typical digital integrated circuit, power pins may be used to receive a ground power supply voltage of 0 volts, a logic-level power supply voltage of 1.0 volts, and an elevated power supply voltage of 2.5 volts.

Circuit designers strive to use power pins efficiently. There is a reluctance to add power pins to an integrated circuit, even if a particular circuit design requires a power supply voltage that is not readily available from existing power supply pins. When extra power supply pins are added to an integrated circuit, the integrated circuit die must be made larger to accommodate the extra power supply pins or existing data pins must be converted to power supply pins. Increasing the size of the integrated circuit die can be expensive and can reduce device yields. At the same time, converting data pins to power pins is generally not desirable because this reduces the number of pins that are available for input and output operations and may require the integrated circuit to operate more slowly than would otherwise be necessary.

To avoid using additional power supply pins, circuit designers use on-chip voltage generation circuitry to generate new power supply voltages from the standard power supply voltages that are already available. If, as an example, a new power supply voltage of −0.5 volts is required, an on-chip voltage generator can be used to produce this voltage from standard ground and positive power supply voltages that are available from existing power supply pins. By generating the new power supply voltage using on-chip circuitry, it is not necessary to use an additional power supply pin to receive the new power supply voltage. System design tasks are also simplified, because it is not necessary to externally produce the new power supply voltage.

One popular type of on-chip voltage generator is based on charge pump circuitry. Charge pumps contain a number of stages. The stages in a charge pump are driven by true and complementary versions of a clock signal. The size of the clock signal influences the efficiency of the charge pump. In environments in which relatively low voltage clock signals are used, charge pump efficiency may be reduced.

It would therefore be desirable to provide charge pumps that can operate efficiently with low voltage clock signals on integrated circuits such as programmable integrated circuits.

### SUMMARY

In accordance with the present invention, charge pump circuitry is provided. The charge pump circuitry may be used on any suitable integrated circuit, such as a programmable integrated circuit.

The charge pump circuitry may have a number of stages. Each stage may be formed from a diode and a capacitor. Oscillator and control circuitry in the charge pump circuitry may generate clock signals. The clock signals may be applied to the capacitors. The charge pump circuitry may produce an output voltage. A voltage regulator may be used to regulate the output voltage from the charge pump.

The integrated circuit may contain programmable elements that produce static control signals. The control signals may be used to adjust the oscillator and control circuitry and the voltage regulator.

The capacitors may be based on varactors, improving performance, particularly when low voltage clock signals are used.

Further features of the invention, its nature and various advantages will be more apparent from the accompanying drawings and the following detailed description.

### BRIEF DESCRIPTION OF THE DRAWINGS

FIG. 1 is a diagram of an illustrative programmable integrated circuit in accordance with an embodiment of the present invention.

FIG. 2 is a circuit diagram of illustrative charge pump circuitry in accordance with an embodiment of the present invention.

FIG. 3 is a diagram of an illustrative negative charge pump circuit in accordance with an embodiment of the present invention.

FIG. 4 is a diagram of an illustrative positive charge pump circuit in accordance with an embodiment of the present invention.

FIGS. 5, 6, 7, 8, and 9 are timing diagrams showing how a charge pump of the type shown in FIG. 3 may be used to generate an output voltage in accordance with an embodiment of the present invention.

FIG. 10 is a circuit diagram comparing how the capacitance of metal-oxide-semiconductor transistor capacitors and varactor capacitors vary as a function of applied voltage.

FIGS. 11 and 12 are cross-sectional diagrams of illustrative varactors that may be used to form capacitors in charge pump circuitry in accordance with an embodiment of the present invention.

### DETAILED DESCRIPTION

The present invention relates to charge pump circuitry and to integrated circuits with charge pump circuitry. The integrated circuits in which the charge pump circuitry may be used may be any suitable type of integrated circuits such as microprocessors, digital signal processors, or application specific integrated circuits. The integrated circuits in which the charge pump circuitry may be used may also be programmable integrated circuits. Examples of programmable integrated circuits include programmable logic devices (also sometimes referred to as field-programmable gate arrays) and integrated circuits that have programmable circuitry, but which are not typically referred to as programmable logic devices, such as microprocessors, digital signal processors, or application specific integrated circuits that contain programmable circuitry.

The charge pump circuitry is sometimes described herein in the context of programmable integrated circuits such as programmable logic devices as an example. Programmable logic device integrated circuits and other programmable integrated circuits can be customized using configuration data. In a typical scenario, a logic designer uses a computer-aided design (CAD) system in designing a desired logic circuit. The computer-aided design system uses information on the hardware capabilities of a programmable circuit to generate configuration data.

Programmable logic devices and other programmable circuits contain programmable elements. The programmable elements may be based on any suitable programmable technology such as fuses, antifuses, laser-programmed elements, electrically-programmed elements, nonvolatile memory elements such as electrically-programmed polysilicon fuses, volatile memory elements, mask-programmed elements, etc. Mask-programmed devices may be programmed during device fabrication. In a typical scenario, volatile programmable elements are based on random-access memory (RAM) cells and nonvolatile fuses such as electrically-programmable polysilicon fuses.

To customize a typical programmable logic device such as a RAM-based device to implement a desired logic circuit, configuration data produced by a computer-aided design system is loaded into programmable memory elements on the device. During operation of the programmable logic device, each memory element provides a static output signal based on its loaded configuration data. The outputs signals from the memory elements are applied to n-channel and p-channel metal-oxide-semiconductor transistors in regions of programmable logic on the programmable logic device. This configures the programmable logic of the device so that the programmable logic device implements the desired logic circuit. Nonvolatile memory elements within the device may be configured during manufacturing to adjust circuits so that they perform within desired specifications (as an example).

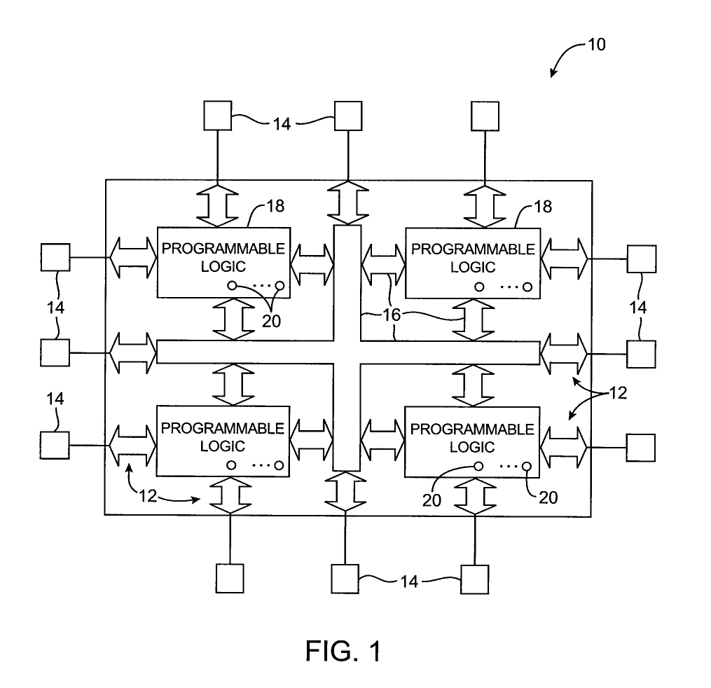

An illustrative programmable logic device 10 in accordance with the present invention is shown in FIG. 1. Programmable logic device 10 has input-output circuitry 12 for driving signals off of device 10 and for receiving signals from other devices via input-output pins 14. Interconnection resources 16 such as global and local vertical and horizontal conductive lines and busses are used to route signals on device 10. Interconnection resources 16 include fixed interconnects (conductive lines) and programmable interconnects (i.e., programmable connections between respective fixed interconnects). Programmable logic 18 may include combinational and sequential logic circuitry. The programmable logic 18 may be configured to perform a custom logic function. The programmable interconnects associated with interconnection resources 16 may be considered to be a part of programmable logic 18.

Programmable logic device 10 contains programmable elements 20 such as random-access memory cells and nonvolatile elements such as polysilicon fuses. Programmable elements 20 (e.g., volatile elements such as random-access memory cells) can be loaded with configuration data (also called programming data) using pins 14 and input-output circuitry 12. The programmable elements each provide a corresponding static control output signal that controls the state of an associated logic component in programmable logic 18. The programmable element output signals are typically used to control the gates of metal-oxide-semiconductor (MOS) transistors. Most of these transistors are generally n-channel metal-oxide-semiconductor (NMOS) pass transistors in programmable components such as multiplexers, look-up tables, logic arrays, AND, OR, NAND, and NOR logic gates, etc. When a programmable element output is high, the pass transistor controlled by that programmable element is turned on and passes logic signals from its input to its output. When the programmable element output is low, the pass transistor is turned off and does not pass logic signals.

The programmable elements may be loaded from any suitable source. In a typical arrangement, the programmable elements are loaded from an external erasable-programmable read-only memory and control chip called a configuration device via pins 14 and input-output circuitry 12. Nonvolatile elements may be electrically programmed during manufacturing using programming equipment or on-chip circuits (as examples).

The circuitry of device 10 may be organized using any suitable architecture. As an example, the logic of programmable logic device 10 may be organized in a series of rows and columns of larger programmable logic regions each of which contains multiple smaller logic regions. The logic resources of device 10 may be interconnected by interconnection resources 16 such as associated vertical and horizontal conductors. These conductors may include global conductive lines that span substantially all of device 10, fractional lines such as half-lines or quarter lines that span part of device 10, staggered lines of a particular length (e.g., sufficient to interconnect several logic areas), smaller local lines, or any other suitable interconnection resource arrangement. If desired, the logic of device 10 may be arranged in more levels or layers in which multiple large regions are interconnected to form still larger portions of logic. Still other device arrangements may use logic that is not arranged in rows and columns.

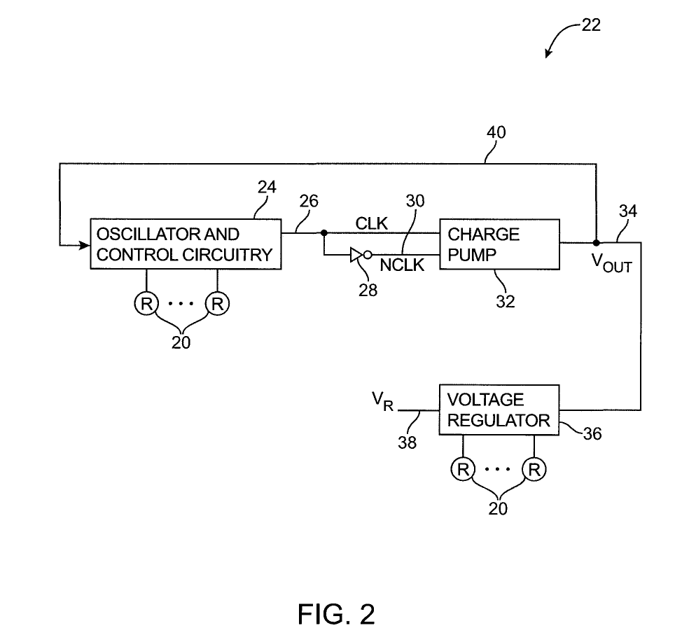

Illustrative charge pump circuitry 22 is shown in FIG. 2. Circuitry 22 may include oscillator and control circuitry 24. An oscillator within circuitry 24 may be used to generate clock signals such as clock signal CLK on output line 26. The oscillator may produce clock signals of any suitable magnitude and frequency. As an example, the magnitude of the clock signal CLK may be 0.9 volts (e.g., less than one volt) or may be 2.5 volts (as examples). During operation, the signal CLK may vary between a low value of Vss (e.g., 0 volts) and its high value (e.g., 0.9 volts or 2.5 volts, etc.) The frequency of CLK may be, for example, 50 MHz to 100 MHz or more. The shape of the CLK signal may be, for example, a square wave. Oscillator 22 may produce other suitable frequencies and waveforms if desired.

An inverter such as inverter 28, which may be part of oscillator and control circuitry 24, may be used to invert the signal CLK. As shown in FIG. 2, the inverted version of CLK, which may be referred to as NCLK, may be produced on output line 30.

Clock signal CLK on line 26 and inverted clock signal NCLK on line 30 may be provided to charge pump 32. Charge pump 32 may use the signals CLK and NCLK to produce a desired output voltage Vout on output line 34. The magnitude of Vout is determined by the frequency of the oscillator in circuitry 24, the sizes of the components in charge pump 32, the number of stages in the charge pump, and the size of the clock signals on lines 26 and 30.

If desired, a voltage regulator 36 may be used to provide a regulated output voltage Vr on output line 38 based on voltage Vout. The voltage Vr may be lower than Vout on output 34. The use of voltage regulator 36 may therefore allow the regulated voltage Vr to have a value that is closer to Vss than would be possible when using charge pump 32 by itself to produce voltage Vout. The settings of the voltage regulator may be set by the states of programmable elements 20 (e.g., random-access memory cells loaded with configuration data or nonvolatile memory elements such as electrically programmed polysilicon fuses whose states are adjusted during manufacturing). The programmable elements that are used to adjust the state of programmable voltage regulator 36 may, for example, be used to produce static control signals that adjust a programmable resistor tree that is associated with a feedback loop and operational amplifier control circuit.

A feedback path 40 may be used to provide voltage Vout to control circuitry in oscillator and control circuitry 24. When the value of Vout rises above a desired value, the control circuitry may lower the frequency of the clock signals to reduce Vout. When the value of Vout on feedback path 40 rises above its desired value, the control circuitry may increase the frequency of the clock signals to raise Vout.

The control circuitry may include, for example, a voltage divider that produces a voltage that is a fraction of Vout and an operational amplifier that compares this voltage to a reference voltage to produce a corresponding control signal. The control signal that is produced by the operational amplifier may be provided to the control input of an oscillator in circuitry 24. The oscillator may be, for example, a current controlled oscillator. A programmable current source may be used to supply an adjustable trim current to the current-controlled oscillator. Programmable elements 20 (e.g., random-access memory cells or nonvolatile elements such as fuses) may be used to produce static control signals that adjust the magnitude of the control current produced by the programmable current source. The current that is produced by the programmable current source may be set to a value that compensates for any process variations that may have arisen during the fabrication of the oscillator. If desired, the oscillator may be fixed (non-programmable) or other programmable circuitry may be used to programmably adjust the oscillator.

The oscillator circuitry in circuitry 24 may produce any suitable number of clock phases. With one suitable arrangement, circuitry 24 may produce four or more clock phases (e.g., 4, 8, or 16 clock phases). These clock phases may be evenly distributed. For example, in an arrangement with four clock phases, each clock signal CLK may be shifted by 45° with respect to the next and each inverted clock NCLK may be shifted by 45° with respect to the next. In multiphase clock arrangements such as this, each clock phase is staggered with respect to the next, so that the downstream circuitry operates more smoothly and makes less abrupt current demands on the power supply. This helps to lower ripple on the output voltage Vout. In the illustrative arrangement of FIG. 2, which is shown as an example, charge pump circuitry 22 is using a single clock phase.

Charge pump 32 may be a positive charge pump or a negative charge pump. A positive charge pump may be used to generate a positive voltage Vout. A negative charge pump may be used to generate a negative voltage Vout.

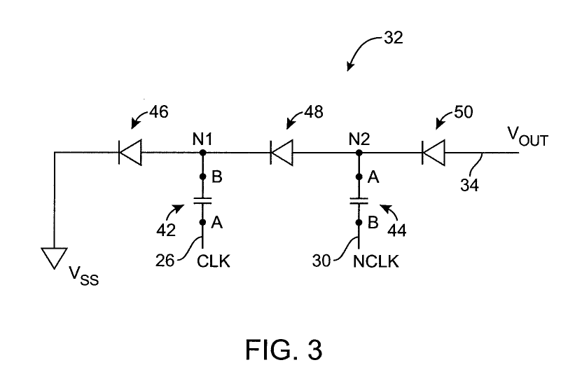

Charge pump 32 may have any suitable number of stages. An illustrative negative charge pump with two stages is shown in FIG. 3. This is merely illustrative. Charge pump 32 may have any suitable number of stages (e.g., three or more stages).

As shown in FIG. 3, clock signal CLK and its inverse NCLK may be applied to terminals 26 and 30, respectively. Capacitors 42 and 44 may be formed from varactors and are sometimes referred to as varactor-based capacitors. Each capacitor may have two terminals, labeled A and B in FIG. 3. The use of varactor-based capacitors in charge pump 32 rather than metal-oxide-semiconductor field effect transistor (MOSFET) capacitors helps improve the amount of charge that is transferred between stages on each clock (i.e., the amount of charge that is dumped on each cycle). In negative charge pumps, such as the charge pump of FIG. 3, the amount of charge that is transferred between stages on each falling clock edge is increased by using varactor-based capacitors. In positive charge pumps, the amount of charge that is transferred between stages on each rising clock edge is increased by using varactor-based capacitors.

Charge pump 32 has diodes 46, 48, and 50. Diodes 46, 48, and 50 may be formed from any suitable diode structures. With one illustrative arrangement, diodes 46, 48, and 50 are formed from MOSFET devices. In this type of arrangement, the body, drain, and gate terminals of a metal-oxide-semiconductor (MOS) transistor are shorted together to form a first diode terminal and the source terminal of the MOS transistor forms a second diode terminal.

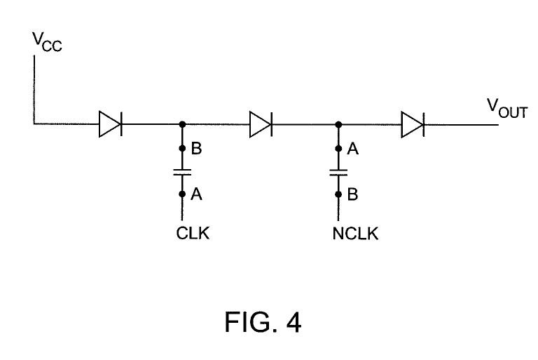

Charge pumps of the type shown in FIG. 3 produce output voltages Vout that are less than ground voltage Vss (e.g., 0 volts) and are therefore sometimes referred to as negative charge pumps. Charge pumps of the type shown in FIG. 4 produce output voltages Vout that are positive and are therefore sometimes referred to as positive charge pumps. Both negative and positive charge pumps may be used on an integrated circuit such as programmable logic device integrated circuit 10 of FIG. 1.

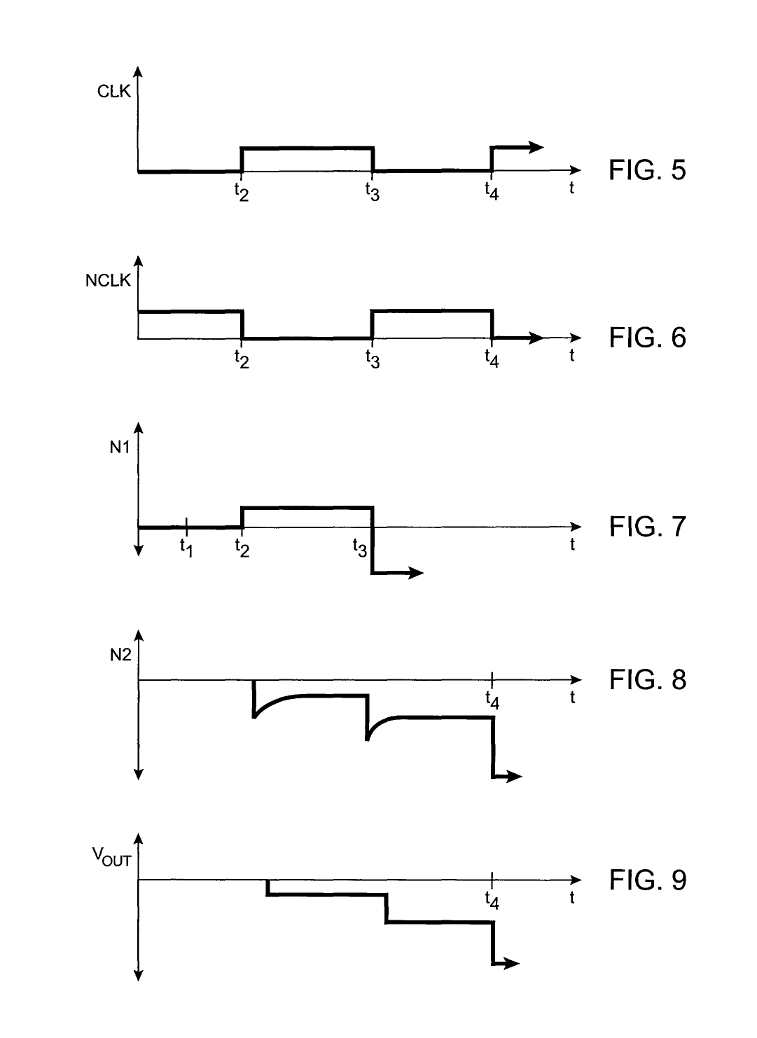

The operation of charge pump 32 of FIG. 3 is shown in the timing diagrams of FIGS. 5, 6, 7, 8, and 9. The clock signals CLK and NCLK are shown in FIGS. 5 and 6, respectively. The voltage on node N1 is shown in FIG. 7. The voltage on node N2 is shown in FIG. 8. The charge pump output voltage Vout is shown in FIG. 9.

Initially, at time t₁, the voltage on node N1 of charge pump 32 is at 0 volts, as shown in FIG. 7. At time t₂, the clock signal CLK goes high and its inverse NCLK goes low. During the rise in the signal CLK at time t₂, the voltage on line 26 goes high. As a result, the voltage at node N1 rises at time t₂. The rise in the voltage at node N1 turns on diode 46. The maximum rise in the voltage at node N1 is capped at the turn-on voltage of diode 46 (about 0.6 volts or one transistor threshold voltage Vt), which is less than the magnitude of CLK. Clock signal NCLK goes low at time t₂, which causes node N2 to go low, as shown in FIG. 8. Diode 48 is reverse biased, so there is no contention between the voltages at nodes N1 and N2.

At time t₃, the signal CLK goes low and the signal NCLK goes high. The drop in signal CLK causes the voltage on node N1 to drop, as shown in FIG. 7. At the same time, clock signal NCLK goes high. The voltage at node N2 rises to one diode turn-on voltage (about 0.6 volts or one transistor threshold voltage Vt) higher than the voltage at node N1, because diode 48 is turned on.

At time t₄, the signal CLK goes high and the signal NCLK goes low. The voltage across capacitor 44 does not change during the transitions at time t₄, so as shown in FIG. 8 the voltage at node N2 drops at time t₄, tracking the drop in the NCLK signal on terminal 30. This forces the voltage Vout on the output terminal of charge pump 32 low, as shown in FIG. 9. The voltage Vout is one diode turn-on voltage higher than the voltage at N2, because diode 50 is turned on.

As this discussion illustrates, the negative charge pump 32 of FIG. 3 produces a negative voltage Vout at its output.

The number of stages in charge pump 32 and the sizes of the clock signals that are used to clock the stages affect the size of the output voltage Vout. For a given number of stages, the size of the output voltage Vout can be increased by increasing the size of CLK and NCLK. In some modern circuit architectures, however, it may be desirable to use relatively low values of CLK and NCLK (e.g., to minimize power consumption and/or to utilize the relatively lower power supply voltages that are commonly available on such integrated circuit). As an example, it may be desirable to use clock signals CLK and NCLK with a magnitude of about 0.9 volts (as an example). Particularly in environments such as these in which the magnitude of the clock signal is less than one volt, it may be desirable to use varactor-based capacitors in charge pump 32. Varactor-based capacitors may also produce performance enhancements for charge pumps with larger clock signals (e.g., greater than one volt).

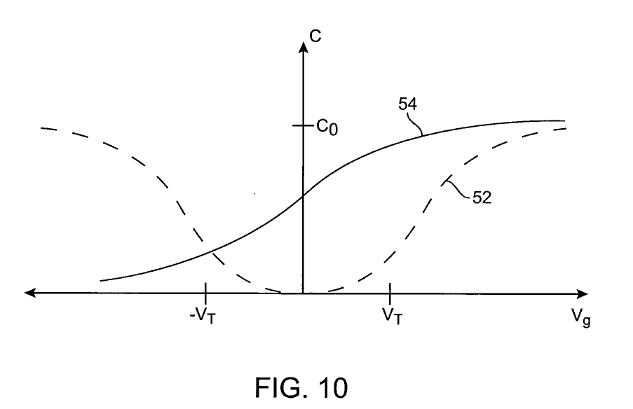

The capacitance produced by varactor-based capacitors such as capacitors 42 and 44 of FIG. 3 is compared to the capacitance produced by MOS capacitors in the graph of FIG. 10. The horizontal axis Vg represents the voltage applied across the capacitor's terminals (e.g., terminals A and B in the varactor-based capacitors of FIG. 3). Dashed line 52 shows how the capacitance of metal-oxide-semiconductor transistor capacitors varies as a function of applied voltage Vg. The voltage Vt is equal to an MOS transistor threshold voltage (e.g., about 0.6 V). As shown, the capacitance of the MOS capacitor is relatively low at voltages between −Vt and +Vt. In this regime, an inversion layer has not been formed under the MOS transistor gate, so the capacitance of a capacitor formed from the MOS transistor structure is low. Only when the voltage across an MOSFET capacitor has a magnitude greater than Vt does the capacitance of the MOSFET capacitor rise significantly (e.g., to capacitance Cₒ). In contrast, the capacitance of a varactor-based capacitor is relatively large throughout voltage range −Vt to Vt, and reaches capacitance Cₒ at lower voltage levels. Unlike the MOS capacitor of line 52, the varactor-based capacitor of line 54 has a non-zero capacitance at a voltage Vg of 0 volts.

During operation, the clock signals CLK and NCLK are applied across the terminals of the charge pump capacitors. In a charge pump that uses relatively large clock signals (e.g., clock signals of 2.5 volts), the average capacitance of an MOS capacitor might be acceptably high. However, particularly in situations in which the clock signals have smaller magnitudes (e.g., ranging from 0 to 0.9 volts), the average capacitance of an MOS capacitor will be small. Because of the higher capacitances of the varactor-based capacitor (particularly at low voltages such as 0-0.9 volts or other clock signal voltages that are close to Vt), the average capacitance of a varactor-based capacitor as the clock signal rises from 0 volts to its maximum value is larger than the average capacitance of an MOS capacitor as the clock signal rises from 0 volts to its maximum value. This increased capacitance increases the amount of charge that is transferred between charge pump stages on each clock cycle. The larger capacitances exhibited by varactor-based capacitors for a given amount of capacitor real estate therefore allow charge pumps with varactor-based capacitors to exhibit improved efficiency when compared to charge pumps with MOS capacitors.

Varactor-based capacitors also exhibit superior high-speed capabilities. With MOS-based capacitors, a finite amount of time is needed to form a channel under the MOS gate oxide. In contrast, varactor-based capacitors already have a conductive region formed by majority carriers under their gate oxides. Varactors-based capacitors also generally have lower parasitic inductances than MOS capacitors for a give size. Because of these attributes, charge pumps with varactor-based capacitors can operate at higher clock frequencies than charge pumps with MOS capacitors. Increased clock frequencies can be beneficial, because they reduce the amount of charge lost in the charge pump due to leakage between clock transitions (e.g., between the negative-going clock edges in a negative charge pump). By reducing charge leakage, charge pump performance can be enhanced.

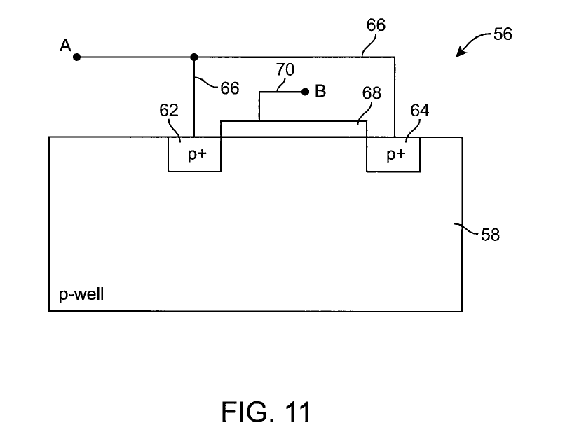

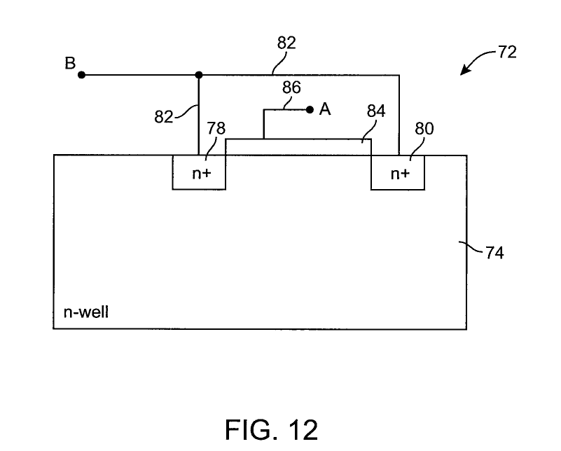

Cross sections of illustrative capacitors formed from varactors are shown in FIGS. 11 and 12. The varactors may be formed from any suitable semiconductor. In a typical arrangement, the varactors are formed from silicon and are fabricated on a wafer that includes complementary metal oxide semiconductor (CMOS) circuits.

The varactor-based capacitor of FIG. 11 is formed in a p-type well 58. P+ regions 62 and 64 are located on opposite ends of gate oxide 68. Regions 62 and 64 have the same doping type (p-type) as p-type well 58. In an n-channel MOS transistor, regions 62 and 64 would be doped n+ rather than p+ and would form source and drain contacts, whereas an additional region would be provided to form a p+ body contact. In varactor 56, conductive lines 66 are used to short p+ regions 62 and 64 to capacitor terminal A. Conductive line 70 is used to short the gate contact of varactor 56 to capacitor terminal B.

The varactor-based capacitor of FIG. 12 is formed in an n-type well 74. N+contact regions 78 and 80, which have the same doping type as n-well 74, are located on opposite ends of gate oxide 84. In a p-channel MOS transistor, regions 78 and 80 would be doped p+rather than n+ and would form source and drain contacts, whereas an additional region would be provided to form an n+body terminal. In varactor 72, conductive lines 82 are used to electrically connect n+ regions 78 and 84 to capacitor terminal B. Conductive path 86 is used to short the gate contact of varactor 72 to capacitor terminal A.

As shown in the cross-sectional views of FIGS. 11 and 12, in capacitors that are formed from varactors, the “body” terminal and the device contacts that are formed adjacent to the gate have the same doping type as the semiconductor well (e.g., the silicon well) in which the varactor is formed. One capacitor terminal is formed by shorting the doped regions together, whereas another capacitor terminal is formed from the varactor's gate. Because the contacts adjacent to the gate have the same doping type as the well, there are majority carriers (e.g., electrons in an n-well) under the gate, even in the absence of a non-zero gate voltage Vg. As a result, the capacitance of a varactor-based capacitor is non-zero at a Vg value of 0 volts, as shown by line 54 in FIG. 10. In general, either n-well or p-well varactors can be used to form the charge pump varactor-based capacitors.

The foregoing is merely illustrative of the principles of this invention and various modifications can be made by those skilled in the art without departing from the scope and spirit of the invention.

What is claimed is:

1. Charge pump circuitry, comprising:
a plurality of diodes; and
a plurality of varactor-based capacitors, wherein each of the varactor-based capacitors is connected to a respective one of the diodes to form a respective charge pump stage.

2. The charge pump circuitry defined in claim 1 wherein the varactor-based capacitors each comprise:
a first terminal;
a second terminal;
an n-well;
a gate formed over the n-well that is electrically connected to the second terminal; and
first and second n+contact regions in the n-well that are adjacent to the gate and that are electrically connected to the first terminal.

3. The charge pump circuitry defined in claim 1 wherein the varactor-based capacitors each comprise:
a first terminal;
a second terminal;
a p-well;
a gate formed over the p-well that is electrically connected to the second terminal; and
first and second p+contact regions in the p-well that are adjacent to the gate and that are electrically connected to the first terminal.

4. The charge pump circuitry defined in claim 1 further comprising:
oscillator and control circuitry that generates clock signals for the charge pump stages;
an output terminal at which a charge pump output voltage is produced by the charge pump stages; and
a voltage regulator that receives the output voltage and that produces a corresponding regulated voltage.

5. The charge pump circuitry defined in claim 1 further comprising:
oscillator and control circuitry that generates clock signals for the charge pump stages;
an output terminal at which a charge pump output voltage is produced by the charge pump stages;
a voltage regulator that receives the charge pump output voltage and that produces a corresponding regulated voltage; and
programmable elements that produce control signals for the voltage regulator that adjust the regulated voltage.

6. The charge pump circuitry defined in claim 1 further comprising:
oscillator and control circuitry that generates clock signals for the charge pump stages;
an output terminal at which a charge pump output voltage is produced by the charge pump stages;
a voltage regulator that receives the charge pump output voltage and that produces a corresponding regulated voltage; and
programmable elements that produce control signals for the voltage regulator that adjust the regulated voltage and that produce control signals that adjust the oscillator and control circuitry.

7. A programmable integrated circuit, comprising:
programmable elements that produce static control signals;
programmable logic that is configured by the static control signals; and
charge pump circuitry, wherein the charge pump circuitry includes a plurality of charge pump stages formed from a plurality of diodes and a plurality of varactor-based capacitors, wherein each of the varactor-based capacitors is connected to a respective one of the diodes in a respective one of the charge pump stages.

8. The programmable integrated circuit defined in claim 7 further comprising a programmable voltage regulator that regulates output signals from the charge pump circuitry.

9. The programmable integrated circuit defined in claim 7 further comprising oscillator circuitry that supplies clock signals to the varactor-based capacitors.

10. The programmable integrated circuit defined in claim 7 wherein the varactor-based capacitors each comprise:
a first terminal;
a second terminal;
an n-well;
a gate formed over the n-well that is electrically connected to the second terminal; and
first and second n+contact regions in the n-well that are adjacent to the gate and that are electrically connected to the first terminal.

11. The programmable integrated circuit defined in claim 7 wherein the varactor-based capacitors each comprise:
a first terminal;
a second terminal;
a p-well;
a gate formed over the p-well that is electrically connected to the second terminal; and
first and second p+contact regions in the p-well that are adjacent to the gate and that are electrically connected to the first terminal.

12. Charge pump circuitry, comprising:
an oscillator that generates clock signals;
a plurality of diodes, each diode having a first diode terminal and a second diode terminal; and
a plurality of varactor-based capacitors, each varactor-based capacitor receiving a respective one of the clock signals and being connected to a respective one of the first diode terminals.

13. The charge pump circuitry defined in claim 12 further comprising programmable elements that generate control signals that are provided to the oscillator.

14. The charge pump circuitry defined in claim 12 further comprising a programmable voltage regulator that regulates output signals from the charge pump stages.

15. The charge pump circuitry defined in claim 12 wherein the varactor-based capacitors each comprise:
a first terminal;
a second terminal;
an n-well;
a gate formed over the n-well that is electrically connected to the second terminal; and
first and second n+contact regions in the n-well that are adjacent to the gate and that are electrically connected to the first terminal.

16. The charge pump circuitry defined in claim 12 wherein the varactor-based capacitors each comprise:
a first terminal;
a second terminal;
a p-well;
a gate formed over the p-well that is electrically connected to the second terminal; and
first and second p+contact regions in the p-well that are adjacent to the gate and that are electrically connected to the first terminal.

17. The charge pump circuitry defined in claim 12 further comprising programmable elements that generate control signals that are provided to the oscillator, wherein the varactor-based capacitors each comprise:
a first terminal;
a second terminal;
a semiconductor region that has an associated doping type;
a gate formed over the semiconductor region that is electrically connected to the second terminal; and
first and second contact regions in the semiconductor region that have the same doping type as the semiconductor region, that are adjacent to the gate, and that are electrically connected to the first terminal.

18. The charge pump circuitry defined in claim 12, further comprising a voltage regulator that regulates output signals from the charge pump stages, wherein the varactor-based capacitors each comprise:
a first terminal;
a second terminal;
a semiconductor region that has an associated doping type;
a gate formed over the semiconductor region that is electrically connected to the second terminal; and
first and second contact regions in the semiconductor region that have the same doping type as the semiconductor region, that are adjacent to the gate, and that are electrically connected to the first terminal.

19. The charge pump circuitry defined in claim 12, further comprising:
a voltage regulator that regulates output signals from the charge pump circuitry; and
programmable elements that generate control signals that are provided to the oscillator, wherein the varactor-based capacitors each comprise:
a first terminal;
a second terminal;
a semiconductor region that has an associated doping type;
a gate formed over the semiconductor region that is electrically connected to the second terminal; and
first and second contact regions in the semiconductor region that have the same doping type as the semiconductor region, that are adjacent to the gate, and that are electrically connected to the first terminal.

20. The charge pump circuitry defined in claim 12, further comprising:
a programmable voltage regulator that regulates output signals from the charge pump circuitry; and
programmable elements that generate control signals that are provided to the oscillator, wherein the varactor-based capacitors each comprise:
a first terminal;
a second terminal;
a semiconductor region that has an associated doping type;
a gate formed over the semiconductor region that is electrically connected to the second terminal; and
first and second contact regions in the semiconductor region that have the same doping type as the semiconductor region, that are adjacent to the gate, and that are electrically connected to the first terminal, wherein the clock signals have a magnitude of less than one volt.
